(19) United States
(12) Patent Application Publication
(10) Pub. No.: US 2026/0274043 A1
(43) Pub. Date: Sep. 17, 2026

(54) METHOD AND SYSTEM FOR CLIMATE CONTROL SYSTEM COMPRESSOR

(71) Applicant: Ford Global Technologies, LLC, Dearborn, MI (US)

(72) Inventors: Alan Gutowski, Wixom, MI (US); Saad Bhatti, Warren, MI (US); Peter Turpel, Farmington Hills, MI (US); Aaron Vandiver, West Bloomfield Township, MI (US)

(21) Appl. No.: 19/078,073

(22) Filed: Mar. 12, 2025

(51) Int. Cl. B60H 1/32

(52) U.S. Cl. CPC B60H 1/3205; B60H 1/3222; B60H 2001/3238; B60H 2001/3248; B60H 2001/3272; B60H 2001/3292

(57) ABSTRACT

A method for controlling a climate control system is disclosed. In one example, the climate control system includes a variable compressor. A speed or displacement of the variable compressor may be adjusted to a reduced value while the compressor has been active for less than a predetermined cumulative amount of time since the climate control system was manufactured.

### FIELD

The present description relates to a method and system for operating a climate control system compressor. The method may be particularly useful during initial use of a climate control system.

### BACKGROUND AND SUMMARY

A vehicle may include a climate control system to increase driver comfort during driving. The climate control system may include a compressor. The compressor may pressurize refrigerant that is circulated within a refrigerant loop. The refrigerant helps to transfer heat within the climate control system. The refrigerant is added to the climate control system during manufacturing of the climate control system. The refrigerant may be combined with a lubricant. The lubricant may be circulated within the refrigerant loop to lubricate the compressor, thereby reducing wear of the compressor. However, upon conclusion of the manufacturing process, the mass of refrigerant and lubricant may be entirely situated within the compressor. Consequently, when the compressor is activated, the entire mass of refrigerant and lubricant may be expelled from the compressor. This may cause wear within the compressor.

The inventors herein have recognized the above-mentioned disadvantage and have developed a method for controlling a vehicle climate control system, comprising: adjusting a compressor flow rate command or a compressor outlet pressure command to be less than a first threshold compressor flow rate or less than a first threshold compressor outlet pressure in response to a compressor being activated for a first time since the vehicle climate system was manufactured.

By adjusting a flow rate or an outlet pressure of a climate control system compressor in response to the climate control compressor being activated for a first time since the vehicle climate control system was manufactured, it may be possible to reduce a possibility of wear within the compressor during initial starting of the compressor. In particular, a speed or displacement of the climate control system compressor may be adjusted so that refrigerant and lubricant in the compressor may be recirculated back to the compressor so that a possibility of operating the compressor without lubricant may be reduced, thereby reducing a possibility of wear within the compressor. Additionally, a similar approach may be applied if the compressor has not been operated for an extended period of time.

The present description may provide several advantages. Specifically, the approach may reduce a possibility of compressor wear when a compressor is activated a first time after the vehicle climate control system was manufactured. In addition, the approach may be applied to variable speed and variable displacement compressors. Further, the approach may be applied to mechanically driven and electrically driven climate control system compressors.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not constrained to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of a vehicle air conditioning system;

FIG. 2 is a schematic diagram of a vehicle climate control system;

FIG. 3 is a plot of an example operating sequence for a vehicle climate control system; and

FIG. 4 is a flowchart for a method for operating a vehicle climate control system.

### DETAILED DESCRIPTION

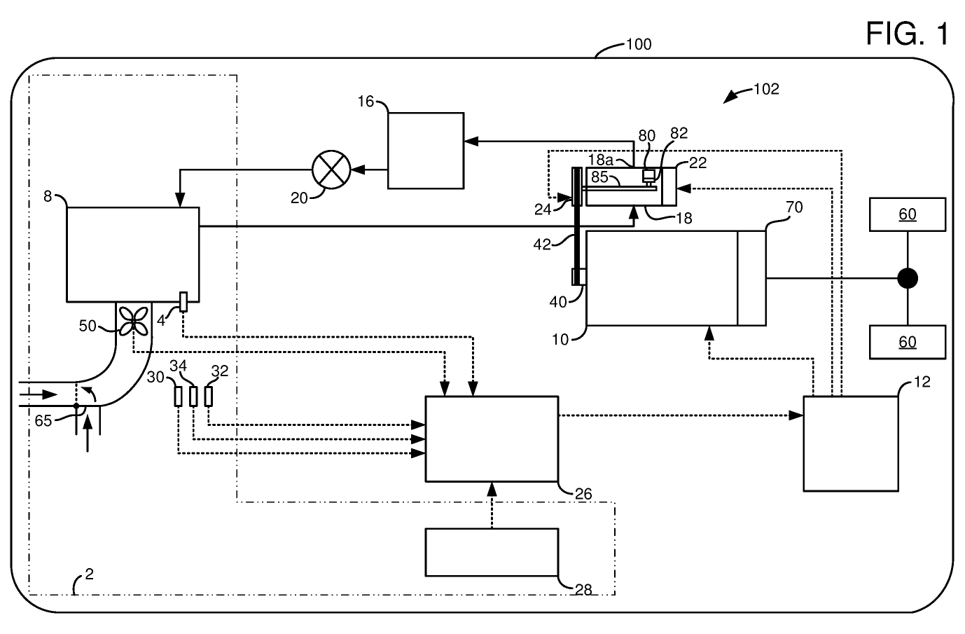

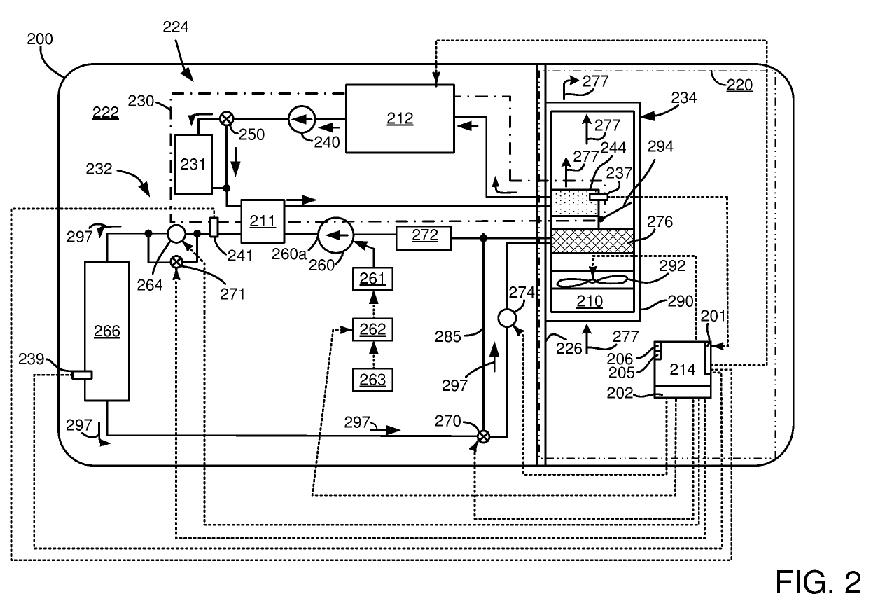

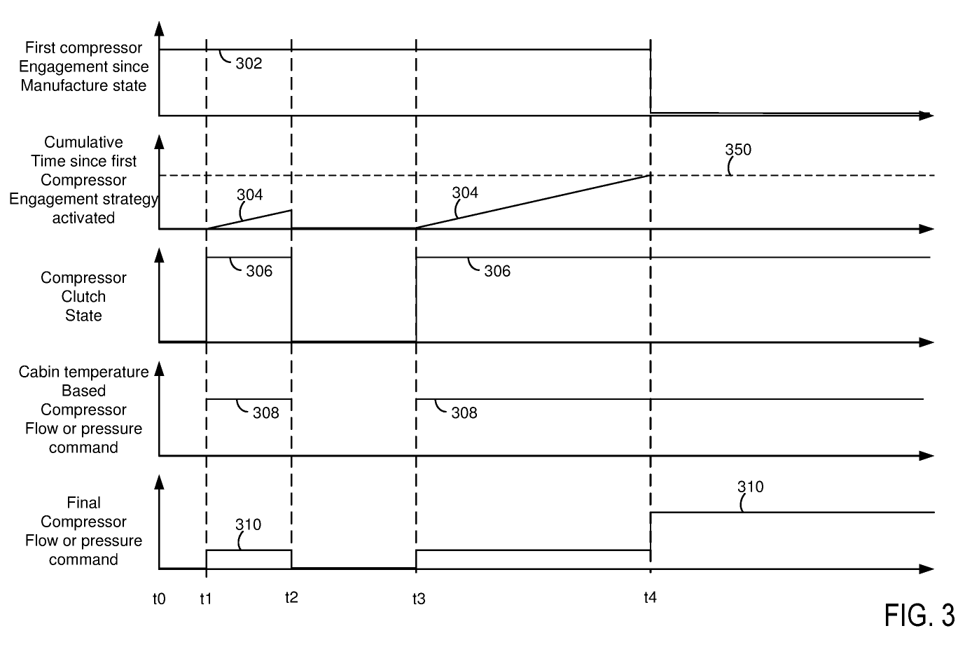

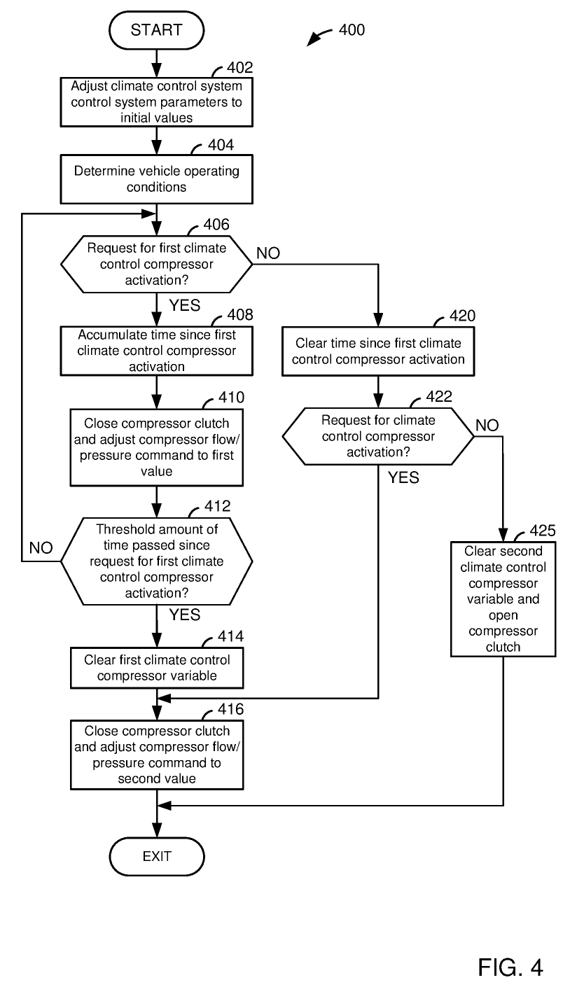

The present description is related to controlling a climate control system compressor of a vehicle. In one non-constraining example, the climate control system may be configured as an air conditioning system as illustrated in FIG. 1. In another example, the climate control system may be configured as a heat pump as shown in FIG. 2. The climate control system may be operated as shown in the sequence of FIG. 3. The climate control system may be operated according to the method of FIG. 4.

Referring now to FIG. 1, climate control system 102 (e.g., an air conditioning system) includes an evaporator 8 for cooling vehicle passenger cabin 2 of vehicle 100. Devices and fluidic passages or conduits are shown as solid lines. Electrical connections are shown as dashed lines. The passenger cabin is indicated via a dot-dot-dashed line.

Air is passed over evaporator 8 via fan 50 and directed around vehicle passenger cabin 2. Climate controller 26 operates fan 50 according to operator settings as well as climate sensors. Temperature sensor 4 provides an indication of the temperature of evaporator 8 to climate controller 26. Cabin temperature sensor 30 provides an indication of cabin temperature to climate controller 26. Similarly, humidity sensor 32 provides climate controller 26 an indication of cabin humidity. Sun load sensor 34 provides an indication of cabin heating from sun light to climate controller 26. Climate controller 26 may also receive operator inputs from operator interface 28 and supplies desired evaporator temperature and actual evaporator temperature to energy conversion device controller 12.

Operator interface 28 allows an operator to select a desired cabin temperature, fan speed, and distribution path for conditioned cabin air (e.g., conditioned fresh air or conditioned recirculated air). Operator interface 28 may include dials and push buttons to select climate settings. In some examples, operator interface 28 may accept inputs via a touch sensitive display.

Refrigerant is supplied to evaporator 8 via evaporator valve 20 after being pumped into condenser 16 via compressor 18. Compressor 18 receives refrigerant gas from evaporator 8 and pressurizes the refrigerant. Heat is extracted from the pressurized refrigerant so that the refrigerant is liquefied at condenser 16. The liquefied refrigerant expands after passing through evaporator valve 20 causing the temperature of evaporator 8 to be reduced relative to passenger cabin temperature.

In this example, compressor 18 is a variable displacement compressor that may be mechanically driven via energy conversion device 10. Compressor 18 includes a clutch 24, a displacement control valve 22, piston 80, and swash plate 82. Piston 80 pressurizes refrigerant in air conditioning system which flows from air conditioner compressor 18 to condenser 16. Swash plate 82 adjusts the stroke of piston 80 to adjust the pressure and/or flow at which refrigerant is output from compressor 18 based on oil flow through variable displacement control valve 22. Energy conversion device controller 12 or climate controller 26 may supply an electric current to control valve 22 so that control valve 22 adjusts the displacement of compressor 18 according to the electric current. Clutch 24 may be selectively engaged and disengaged to supply compressor 18 with rotational energy from energy conversion device 10. In one example, energy conversion device 10 is an engine supplying rotational energy to compressor 18 and wheels 60 via transmission 70. In other examples, energy conversion device 10 may be an electrical motor supplying rotational energy to compressor 18 and wheels 60 via transmission 70. Rotational energy may be supplied to input shaft 85 of compressor 18 from energy conversion device 10 via transfer device 42. In one example, transfer device 42 mechanically couples shaft 40 to climate control compressor 18 via clutch 24. The compressor 18 may be commanded to deliver a flow or pressure at compressor outlet 18a. Shaft 40 may be an engine crankshaft, armature shaft, or other shaft.

In this way, the system of FIG. 1 provides rotational energy to a climate control system compressor to cool the cabin of a vehicle. Specifically, the air conditioner compressor provides a negative torque to load the energy conversion device and compress the refrigerant so that the refrigerant can be subsequently expanded in order to cool the vehicle passenger cabin. The amount of negative torque provided to the energy conversion device by the air conditioner compressor can be adjusting via the clutch and an actuator or valve that adjusts the variable displacement pump.

Referring now to FIG. 2, a vehicle climate control system 224 (e.g., a heat pump) is shown. Devices and fluidic passages or conduits are shown as solid lines. Electrical connections are shown as dashed lines. The passenger cabin is indicated via a dot-dot-dashed line.

The vehicle 200 may include a propulsion source 212. The propulsion source may comprise an electric machine and/or an internal combustion engine. The propulsion source 212 may provide mechanical power to propel vehicle 200. If propulsion source 212 includes an internal combustion engine, it may combust petrol, diesel, alcohol, hydrogen, or a combination of fuels.

The vehicle 200 may include a passenger cabin 220 (e.g., a compartment), a powertrain compartment 222, and a climate control system 224. The passenger cabin 220 may be within vehicle 200 and it may receive one or more occupants. A portion of climate control system 224 may be positioned in passenger cabin 220.

Powertrain compartment 222 may be positioned proximate to passenger cabin 220. One or more power sources, such as internal combustion engine 212, as well as a portion of climate control system 224 may be within powertrain compartment 222. Powertrain compartment 222 may be isolated from the passenger cabin 220 via bulkhead 226. The climate control system 224 may circulate air and/or control or modify the temperature of air that is circulated in the passenger cabin 220. Further, the propulsion source 212 may be heated via climate control system 224 to reduce fuel consumption and emissions. The climate control system 224 may include a coolant subsystem 230, a heat pump subsystem 232, and ventilation subsystem 234.

The coolant subsystem 230, which may also be referred to as a coolant loop, may circulate a coolant, such as glycol, to cool the propulsion source 212. For example, waste heat that is generated by the propulsion source 212 when the propulsion source is running or operational may be transferred to the coolant and then circulated to radiator 231 to propulsion source 212. In at least one example, the coolant subsystem 230 may include a coolant pump 240, a heater core 244, and intermediate heat exchanger 211 that may be fluidly interconnected by conduits or passages such as tubes, hoses, pipes, or the like. The coolant subsystem 230 includes radiator 231 for transferring thermal energy to the ambient air surrounding the vehicle 200. The coolant pump 240 may circulate coolant through the coolant subsystem 230. The coolant pump 240 may be powered by an electrical or non-electrical power source. For example, the coolant pump 240 may be operatively coupled to the propulsion source 212 via a coupling device, or alternatively may be driven by an electrically powered motor. The coolant pump 240 may receive coolant from the propulsion source 212 and circulate the coolant in a closed loop. Specifically, when the climate control system 224 is in a heating mode, coolant may be routed from the coolant pump 240 to valve 250 and intermediate heat exchanger 211, and then to the heater core 244 before returning to the propulsion source 212 as represented by the arrowed lines. When propulsion source 212 is outputting a higher level of thermal energy, coolant may flow from pump 240 to radiator 231 before returning to propulsion source 212 via heater core 244. Heater core heat sensor 237 provides heater core temperature to controller 214.

The heater core 244 may transfer thermal energy from the coolant to air in the passenger cabin 220. The heater core 244 may be positioned in the passenger cabin 220 in the ventilation subsystem 234 and may have any suitable configuration. For example, the heater core 244 may have a plate-fin or tube-fin construction in one or more examples.

The heat pump subsystem 232 may operate in various modes, including, but not constrained to a cooling mode and heating mode. Further, heat pump subsystem 232 may include a plurality of refrigerant circuits that may be isolated from other refrigerant circuits. For example, heat pump subsystem 232 includes a first refrigerant circuit that includes second control valve 270, second expansion valve 274, and interior heat exchanger 276. Heat pump subsystem includes a second refrigerant circuit that includes second control valve 270 and bypass passage 285. In other variants, heat pump subsystem 232 may include additional refrigerant circuits that provide additional functionality. Thus, heat pump subsystem 232 may include a plurality of refrigerant circuits through which refrigerant passes.

In the cooling mode, the heat pump subsystem 232 may circulate a heat transfer fluid, which may be called a refrigerant, to transfer thermal energy from inside the passenger cabin 220 to outside the passenger cabin 220. Refrigerant may pass through interior heat exchanger 276 during cooling mode. In cooling mode, first control valve 271 is in an open state such that first expansion valve 264 is bypassed. Second control valve 270 directs refrigerant to second expansion valve 274, thereby preventing flow through bypass passage 285.

In a heating mode, the heat pump subsystem 232 may transfer thermal energy from exterior heat exchanger 266 to intermediate heat exchanger 211. Intermediate heat exchanger may be a gas to liquid heat exchanger which allows heat to be transferred to coolant, and the coolant may warm the passenger cabin via heater core 244. In heating mode, first control valve 271 is closed such that first expansion valve 264 expands refrigerant that flows to exterior heat exchanger 266. Second control valve 270 directs refrigerant to bypass passage 285, thereby preventing flow through interior heat exchanger 276.

The variable speed compressor 260, which may also be called a pump, may pressurize and circulate the refrigerant through the heat pump subsystem 232. The variable speed compressor 260 may be driven via an electric machine 261 (e.g., a motor). The electric machine 261 may be powered to rotate at varying speeds via an inverter 262 and an electric energy storage device 263 (e.g., a traction battery). The inverter 262 may be controlled via controller 214. The variable speed compressor 260 may provide high pressure refrigerant to first expansion valve 264 and exterior heat exchanger 266 when first control valve 271 is closed. Refrigerant pressure may be determined via pressure sensor 241. Refrigerant may bypass first expansion valve 264 when first control valve 271 is in an open state. In some examples, an oil separator may be placed at the outlet of pump 260. Refrigerant may flow through heat pump subsystem 232 via motive force of variable speed compressor 260 in the direction of arrows 297. The variable speed compressor 260 may be commanded to deliver a flow or pressure at compressor outlet 260a.

The first expansion valve 264 may be positioned between and may be in fluidic communication with variable speed compressor 260 and the exterior heat exchanger 266. Temperature of exterior heat exchanger 266 may be sensed via temperature sensor 239 and input to controller 214. The first expansion valve 264 may be provided to change the pressure of the refrigerant. For example, the first expansion valve 264 may be a thermal expansion valve (TXV) or a fixed or variable position valve that may or may not be externally controlled. The first expansion valve 264 may reduce the pressure of the refrigerant that passes through the first expansion valve 264 from the variable speed compressor 260 to the exterior heat exchanger 266. Therefore, high pressure refrigerant received from the variable speed compressor 260 may exit the first expansion valve 264 at a lower pressure and as a liquid and vapor mixture in the heating mode.

The exterior heat exchanger 266 may be positioned outside the passenger cabin 220. In a cooling mode or air conditioning context, the exterior heat exchanger 266 may function as a condenser and may transfer heat to the surrounding environment to condense the refrigerant from a vapor to a liquid. In a heating mode, the exterior heat exchanger 266 may function as an evaporator and may transfer heat from the surrounding environment to the refrigerant, thereby causing the refrigerant to vaporize.

The second control valve 270 may be positioned between external heat exchanger 266 and second expansion valve 274. The passage between second control valve 270 and second expansion valve 274 allows refrigerant to selectively reach interior heat exchanger 276. In one example, second control valve 270 is a three-way valve that selectively allows refrigerant to flow to second expansion valve 274 or bypass passage 285.

The accumulator 272 may act as a reservoir for storing any residual liquid refrigerant so that vapor refrigerant rather than liquid refrigerant may be provided to the variable speed compressor 260. The accumulator 272 may include a desiccant that absorbs small amounts of water moisture from the refrigerant.

The interior heat exchanger 276 may be fluidly connected to the second expansion valve 274. The interior heat exchanger 276 may be positioned inside the passenger cabin 220. In a cooling mode or air conditioning context, the interior heat exchanger 276 may function as an evaporator and may receive heat from air in the passenger cabin 220 to vaporize the refrigerant. Refrigerant exiting the interior heat exchanger 276 may be routed to the accumulator 272. In the heating mode, interior heat exchanger 276 is bypassed.

The ventilation subsystem 234 may circulate air in the passenger cabin 220 of the vehicle 100. The ventilation subsystem 234 may have a housing 290, a blower 292, and a temperature door 294.

The housing 290 may receive components of the ventilation subsystem 234. In FIG. 2, the housing 290 is illustrated such that internal components are visible rather than hidden for clarity. In addition, airflow through the housing 290 and internal components is represented by the arrowed lines 277. The housing 290 may be at least partially positioned in the passenger cabin 220. For example, the housing 290 or a portion thereof may be positioned under an instrument panel of the vehicle 200. The housing 290 may have an air intake portion 210 that may receive air from outside the vehicle 200 and/or air from inside the passenger cabin 220. For example, the air intake portion 210 may receive ambient air from outside the vehicle 200 via an intake passage, duct, or opening that may be located in any suitable location, such as proximate a cowl, wheel well, or other vehicle body panel. The air intake portion 210 may also receive air exclusively from or more than a predetermined amount (e.g., 75%) from inside the passenger cabin 220 and recirculate such air through the ventilation subsystem 234 (e.g. recirculation mode). One or more doors or louvers may be provided to permit or inhibit air recirculation.

The blower 292 may be positioned in the housing 290. The blower 292, which may also be called a blower fan, may be positioned near the air intake portion 210 and may be configured as a centrifugal fan that may circulate air through the ventilation subsystem 234.

The temperature door 294 may be positioned between the interior heat exchanger 276 and the heater core 244. In the example shown, the temperature door 294 is positioned downstream of the interior heat exchanger 276 and upstream of the heater core 244. The temperature door 294 may block or permit airflow through the heater core 244 to help control the temperature of air in the passenger cabin 220. For example, the temperature door 294 may permit airflow through the heater core 244 in the heating mode such that heat may be transferred from the coolant to air passing through the heater core 244. This heated air may then be provided to a plenum for distribution to ducts and vents or outlets located in the passenger cabin 220. The temperature door 294 may be moved between a plurality of positions to provide air having a desired temperature. In FIG. 2, the temperature door 294 is shown in a full heat position in which airflow is directed through the heater core 244.

Controller 214 includes executable instructions of the method in FIG. 4 to operate the valves, fans, and pumps or compressors of the system shown in FIG. 2. Controller 214 includes inputs 201 and outputs 202 to interface with devices in the system of FIG. 2. Controller 214 also includes a central processing unit 205 and non-transitory memory 206 for executing the method of FIG. 4.

It may be noted that in some example systems, engine 212 and heater core 244 may not be present. In such systems, interior heat exchanger 276 may operate as a condenser in a heating mode and exterior heat exchanger 266 may operate as an evaporator. Further, it may be appreciated that variations of the heat pump system are anticipated.

Thus, the systems of FIGS. 1 and 2 provide for a vehicle climate control system, comprising: a variable speed compressor or a variable displacement compressor; and a controller including executable instructions stored in non-transitory memory that cause the controller to adjust the variable speed compressor or the variable displacement compressor in response to the variable speed compressor or the variable displacement compressor being activated for a first time since a predetermined time. In a first example, the vehicle climate control system includes where the variable speed compressor or the variable displacement compressor being activated includes rotating an input shaft of the variable speed compressor or the variable displacement compressor. In a second example that may include the first example, the vehicle climate control system includes where the predetermined time is a time the vehicle climate system was manufactured. In a third example that may include one or both of the first and second examples, the vehicle climate control system includes where the predetermined time is a most recent time when the vehicle climate control system was deactivated for longer than a predetermined amount of time. In a fourth example that may include one or more of the first through third examples, the vehicle climate control system includes where the predetermined amount of time is greater than four hours. In a fifth example that may include one or more of the first through fourth examples, the vehicle climate control system includes where adjusting the variable speed compressor includes reducing a speed of the variable speed compressor below a speed request that is based on a requested passenger cabin temperature. In a sixth example that may include one or more of the first through fifth examples, the vehicle climate control system includes where adjusting the variable displacement compressor includes reducing a displacement of the variable speed compressor below a displacement request that is based on a requested passenger cabin temperature. In a seventh example that may include one or more of the first through sixth examples, the vehicle climate control system further comprises an electric machine, the electric machine mechanically coupled to the variable speed compressor.

Referring now to FIG. 3, shows plots of a simulated operating sequence according to the method of FIG. 4. The sequence of FIG. 3 may be provided by the climate control systems shown in FIGS. 1 and 2 executing the method of FIG. 4 via instructions stored in non-transitory memory. FIG. 3 includes vertical markers t0-t4 that indicate times of particular interest during the sequence.

The first plot from the top of FIG. 3 is a plot of a climate control system variable (e.g., a binary or floating point variable) versus time. The climate control system variable value is zero when trace 302 is at or near the horizontal axis. The climate control system variable value is non-zero when trace 302 is near the vertical axis arrow. The climate control variable value indicates whether or not the present climate control system compressor engagement is a first compressor activation since a time that the climate control system was manufactured. In particular, trace 302 is a non-zero value (e.g., 1) and indicates that the present climate control system compressor activation is a first activation when trace 302 is near the vertical axis arrow. Trace 302 is a zero value and indicates that the present climate control system compressor activation is a first fully performed climate control system compressor activation since a time that the climate control system was manufactured when trace 302 is near the horizontal axis. A fully performed first compressor activation may occur when the climate control compressor has been continuously activated (e.g., rotating and compressing refrigerant) for a threshold period of time for a first time since the climate control system was manufactured. The vertical axis represents the climate control system variable state. The horizontal axis represents time and time increases from the left side of the plot to the right side of the plot.

The second plot from the top of FIG. 3 is a plot of cumulative time since a first compressor engagement strategy has been activated to rotate the climate control system compressor versus time is shown. The vertical axis represents the cumulative amount of time since the first compressor engagement strategy has been activated. The first compressor engagement strategy is a strategy where a compressor speed or compressor displacement is lower than a compressor speed or compressor displacement that is based on a present desired passenger cabin temperature. The first strategy allows refrigerant and lubricant to be pumped from the compressor at a slower rate so that a possibility of rotating the compressor without lubricant may be reduced. The horizontal axis represents time and time increases from the left side of the plot to the right side of the plot. Trace 304 represents the cumulative amount of time since the first compressor engagement strategy was activated and the cumulative amount of time that the climate control system compressor has been activated (e.g., rotating). Dashed line 350 represents a threshold amount of time that the climate control compressor has to be activated before the second compressor engagement strategy may be activated.

The third plot from the top of FIG. 3 is a plot of climate control system compressor clutch state versus time. The vertical axis represents the climate control system clutch state. The horizontal axis represents time and time increases from the left side of the plot to the right side of the plot. Trace 306 represents the climate control system clutch state. The climate control system clutch is engaged causing the climate control compressor to rotate when trace 306 is at a higher level that is near the vertical axis arrow. The climate control system clutch is disengaged causing the climate control compressor to not rotate when trace 306 is near the horizontal axis.

The fourth plot from the top of FIG. 3 is a plot of a desired cabin temperature based climate control system compressor flow or outlet pressure command versus time. The vertical axis represents the desired cabin temperature based climate control system compressor flow or outlet pressure command and the compressor flow or pressure command increases in the direction of the vertical axis arrow. The horizontal axis represents time and time increases from the left side of the plot to the right side of the plot. The desired cabin temperature based climate control system compressor flow or outlet pressure command is a flow rate command or a pressure command that is based on a desired temperature in the passenger cabin. The desired temperature in the passenger cabin may be requested via a human/machine interface.

The fifth plot from the top of FIG. 3 is a plot of a final climate control system compressor flow or outlet pressure command versus time. The vertical axis represents the final climate control system compressor flow or outlet pressure command and the final compressor flow or pressure command increases in the direction of the vertical axis arrow. The horizontal axis represents time and time increases from the left side of the plot to the right side of the plot. The final climate control system compressor flow or outlet pressure command is a flow rate command or a pressure command that is commanded of the climate control system compressor.

At time t0, manufacturing of the climate control system ends and the vehicle and climate control system are programmed with their initial control parameter conditions. The initial control parameter conditions include setting the climate control system variable to a non-zero value (e.g., one). The cumulative time since a first compressor engagement strategy has been activated to rotate the climate control system compressor is zero and the climate control system clutch is disengaged. The desired cabin temperature based climate control system compressor flow or outlet pressure command has not been issued since the climate control system is not activated. The final compressor flow command or compressor outlet pressure command is zero.

At time t1, the climate control system compressor is activated (e.g., it begins to rotate and compress refrigerant). This causes the amount of time since a first compressor is activated variable to increase with time. The climate control system clutch is engaged and the desired cabin temperature based climate control system compressor flow or outlet pressure command is a medium level non-zero value. However, the final climate control flow rate or pressure command is a value that is less than the desired cabin temperature based climate control system compressor flow or outlet pressure command is a medium level non-zero value. Therefore, the final compressor flow rate or outlet pressure command causes the climate control system compressor to generate less flow or lower pressure as compared to if the climate control system compressor were commanded based on the desired cabin temperature based climate control system compressor flow or outlet pressure command. This action may cause refrigerant and lubricant to flow through the climate control system compressor at a slower rate so that at least some lubricant may remain within the compressor or flow into the compressor. As such, a possibility of wear within the climate control system compressor may be reduced.

At time t2, the climate control system compressor is deactivated (e.g., it stops rotating and compressing refrigerant). This causes the amount of time since a first compressor is activated variable to be reset to zero. The amount of time since a first compressor is activated variable is reset to zero because circulation of the refrigerant and lubricant has not occurred for a sufficient amount of time to ensure adequate initial lubrication of the climate control system compressor. The climate control system clutch is also disengaged and the desired cabin temperature based climate control system compressor flow or outlet pressure command is no longer commanded. Further, the final climate control flow rate or pressure command is not commanded.

At time t3, the climate control system compressor is activated again. This causes the amount of time since a first compressor is activated variable to increase again with time. Since the compressor activation sequence was not finished at time t2, this activation is considered as a first climate control system compressor activation since the time of manufacturing of the compressor was finished. The climate control system clutch is engaged and the desired cabin temperature based climate control system compressor flow or outlet pressure command is a medium level non-zero value. Again, the final climate control flow rate or pressure command is a value that is less than the desired cabin temperature based climate control system compressor flow or outlet pressure command is a medium level non-zero value. As such, the final compressor flow rate or outlet pressure command causes the climate control system compressor to generate less flow or lower pressure as compared to if the climate control system compressor were commanded based on the desired cabin temperature based climate control system compressor flow or outlet pressure command.

At time t4, the amount of time since a first compressor is activated variable reaches threshold 350. This is a sufficient amount of time to ensure initial lubrication of the climate control system compressor is finished. Therefore, the final compressor flow or outlet pressure command switches to follow the cabin temperature based flow or outlet pressure command. This allows the climate control system to achieve the desired passenger cabin temperature. It may be appreciated that the transition to commanding the final compressor flow or outlet pressure command to the cabin temperature based flow or outlet pressure command may be gradually increased instead of increased in a step-wise manner as shown in FIG. 3. The climate control system compressor clutch remains engaged and the climate control system variable value is adjusted to zero to indicate that the first compressor engagement has successfully been performed.

In this way, a variable may indicate whether or not a first climate control system compressor activation has been performed. If a first climate control system compressor activation has not been performed, the final compressor flow or outlet pressure command may be constrained to a lower value so that lubricant is gradually pushed through the compressor, thereby maintaining a desired level of lubrication for the climate control system compressor.

Referring now to FIG. 4, a method for operating a climate control system is shown. The method of FIG. 4 is executable via instructions stored in a system such as those shown in FIGS. 1 and 2. The instructions may be stored in a non-transitory medium. The method of FIG. 4 may provide the sequence that is shown in FIG. 3.

At 402, method 400 adjusts climate control system control parameters to their initial values. In one example, method 400 may adjust a first climate control variable value that indicates whether or not the present climate control system compressor engagement is a first compressor activation since a time that the climate control system was manufactured to a value of one or true. A value of one or true for the first climate control variable may be applied to indicate that the climate control compressor has not been activated for a first time since a time that the climate control system was manufactured and that the compressor has not been operated at a predetermined low flow rate or outlet pressure for a predetermined amount of time. Thus, a value of one or true indicates that execution of a procedure to initially lubricate the climate control compressor has not been achieved for a predetermined amount of time so that adequate compressor lubrication may be ensured. A value of zero or false indicates that execution of the procedure to initially lubricate the climate control compressor has been achieved. The first climate control variable value may be set to a value of one or true exclusively at the time the vehicle that includes the climate control system is manufactured.

Additionally, method 400 may adjust an initialization flow rate command or an initialization outlet pressure for the climate control system compressor to a predetermined low value (e.g., less than 50% of a full scale climate control system compressor command) exclusively at the time that the vehicle is manufactured.

In some examples, method 400 may also set a second climate control variable value that indicates whether or not the present climate control system compressor engagement is a first compressor activation since the climate control system was most recently deactivated for longer than a threshold amount of time (e.g., four or more hours) to a value of one or true if a present climate control system compressor engagement is requested and the present climate control system compressor engagement is a first compressor activation since the climate control system was most recently deactivated for longer than a threshold amount of time. Thus, a value of one or true indicates that execution of a procedure to lubricate the climate control compressor after a period of inactivity has not been performed. A value of zero or false for the second climate control parameter indicates that execution of the procedure to initially lubricate the climate control compressor has been achieved. Method 400 proceeds to 404.

At 404, method 400 determines vehicle operating conditions. Vehicle operating conditions may include but are not constrained to passenger cabin temperature, requested or desired passenger cabin temperature, climate control system compressor speed or displacement, climate control system compressor clutch operating state, vehicle speed, ambient air temperature, etc. Method 400 proceeds to 406.

At 406, method 400 judges whether or not there has been a request for activating the climate control system and its compressor and whether or not the first climate control variable is equal to one or true (e.g., a value of one indicates that the climate control compressor has not been activated for a first time since a time that the climate control system was manufactured and that the compressor has not been operated at a predetermined low flow rate or outlet pressure for a predetermined amount of time). If so, the answer is yes and method 400 proceeds to 408. Otherwise, the answer is no and method 400 proceeds to 420.

Additionally, in some examples, method 400 may also judge whether or not there has been a request for activating the climate control system and its compressor and whether or not the second climate control variable is equal to one or true (e.g., a value of one or true indicates that the climate control compressor has not been activated since the climate control system and its compressor were most recently deactivated for longer than a threshold amount of time). If so, the answer is yes and method 400 proceeds to 408. Otherwise, the answer is no and method 400 proceeds to 420.

A yes answer allows method 400 to begin a gradual dispersion of lubricant within the climate control system compressor, evaporator, condenser, and other components. Doing so before applying a full load to the compressor may reduce a possibility of wear within the compressor.

At 408, method 400 begins to activate the first climate control system activation strategy and method 400 begins to accumulate an amount of time since a most recent activation request of the climate control system and compressor (e.g., a yes answer at step 406). An example of the time accumulation is shown in FIG. 3. As time increases since the most recent activation request of the climate control system and compressor, the amount of accumulated time since the most recent activation request of the climate control system and compressor increases. Method 400 proceeds to 410.

At 410, method 400 closes the climate control system’s compressor clutch and adjusts a flow rate of the compressor or an outlet pressure of the compressor by adjusting a speed or displacement of the climate control system’s compressor to a first predetermined value. The compressor flow rate or outlet pressure may be adjusted before or within a predetermined or threshold amount of time since most recently activating the compressor and the flow rate though the compressor may be adjusted to be less than a threshold flow rate or the compressor outlet pressure may be adjusted to be less than a threshold pressure. These actions may slow lubrication flow through the compressor so that lubrication may be more evenly dispersed through the climate control system’s refrigerant loop, thereby increasing compressor lubrication after starting the compressor. For example, to decrease flow through the climate control system compressor, a speed of the climate control system compressor may be reduced. Similarly, to decrease an outlet pressure of the climate control system compressor, a displacement of the climate control system compressor may be reduced. In one example, the first predetermined value may be lower than a value of the compressor flow rate or outlet pressure that is based on a present desired or requested passenger cabin temperature as shown in FIG. 3. Thus, the compressor speed may be adjusted to 200 RPM or the compressor displacement may be adjusted to 10% of the compressor’s actual total displacement capacity for the first climate control activation when a requested passenger cabin temperature is 23 degrees Celsius and the present passenger cabin temperature is 35 degrees Celsius, which calls for a compressor speed of 2000 RPM or the compressor displacement may be adjusted to 75% of the compressor’s actual total displacement capacity. Method 400 may command the speed of the climate control system compressor or the displacement of the climate control system compressor via adjusting a current flow, a voltage, or a value of a control parameter that is sent to the climate control system compressor speed control device (e.g., an inverter that supplies voltage and current to an electric motor) or climate control system compressor displacement control device (e.g., an electrically operated solenoid or linear actuator). Method 400 proceeds to 412.

At 412, method 400 judges whether or not a first threshold amount of time has passed since method 400 judges that there has been a request for activating the climate control system and its compressor and that the first climate control variable is equal to one or true (e.g., a value of one indicates that the climate control compressor has not been activated for a first time since a time that the climate control system was manufactured and that the compressor has not been operated at a predetermined low flow rate or outlet pressure for a predetermined amount of time).

Additionally, in some examples, method 400 may also judge whether or not a second threshold amount of time has passed since method 400 judges that there has been a request for activating the climate control system and its compressor and that the second climate control variable is equal to one or true (e.g., a value of one or true indicates that the climate control compressor has not been activated since the climate control system and its compressor were most recently deactivated for longer than a threshold amount of time). If method 400 judges that either the first or second threshold amounts of time have been exceeded, the answer is yes and method 400 proceeds to 414. Otherwise, the answer is no and method 400 returns to 406.

At 414, method 400 clears and/or sets a value of the first climate control variable that indicates whether or not the present climate control system compressor engagement is a first compressor activation since a time that the climate control system was manufactured to zero or false. Additionally, for embodiments where method 400 may constrain climate control system compressor speed or outlet pressure for a climate control system compressor that is activated for a first time since the climate control system compressor was most recently deactivated for longer than a threshold amount of time, method 400 may clear and/or set a value of a second climate control variable value to zero or false. Method 400 proceeds to 416.

At 416, method 400 closes the climate control system’s compressor clutch and adjusts a flow rate of the compressor or an outlet pressure of the compressor by adjusting a speed or displacement of the climate control system’s compressor to a second value, where the second value is based on a desired or requested passenger cabin temperature. For example, if the requested passenger cabin temperature is 23 degrees Celsius and the present passenger cabin temperature is 35 degrees Celsius, the compressor speed may be adjusted to 2000 RPM or the compressor displacement may be adjusted to 75% of the compressor’s actual total displacement capacity. Method 400 proceeds to exit.

At 420, method 400 clears the amount of time since the climate control system compressor was activated for a first time since the climate control system was activated. This action allows method 400 to perform circulation of the lubricant within the climate control system for the predetermined amount of time if the activation process is interrupted and the activation time for the compressor is not continuous. Method 400 proceeds to 422.

At 422, method 400 judges whether or not there has been a request for activating the climate control system and its compressor. If so, the answer is yes and method 400 proceeds to 416. Otherwise, the answer is no and method 400 proceeds to 425.

At 425, method 400 clears the second climate control variable by setting its value to zero or false. Method 400 also opens the climate control system clutch to disengage the climate control compressor if it is engaged. Method 400 proceeds to exit.

Thus, the method of FIG. 4 provides for controlling a vehicle climate control system, comprising: adjusting a compressor flow rate command or a compressor outlet pressure command to be less than a first threshold compressor flow rate or less than a first threshold compressor outlet pressure in response to a compressor being activated for a first time since the vehicle climate system was manufactured. In a first example, the method includes where the compressor flow rate command is adjusted before or within a predetermined amount of time since most recently activating the compressor. In a second example that may include the first example, the method includes where the compressor outlet pressure command is adjusted before or within a predetermined amount of time since most recently activating the compressor. In a third example that may include one or both of the first and second examples, the method includes where the first threshold compressor flow rate is less than a vehicle climate control system compressor flow rate command that is based on a requested passenger cabin temperature when the compressor flow rate command is adjusted, or where the first threshold compressor outlet pressure is less than a vehicle climate control system compressor outlet pressure command that is based on the requested passenger cabin temperature when the compressor outlet pressure command is adjusted. In a fourth example that may include one or more of the first through third examples, the method includes where the compressor flow rate command or the compressor outlet pressure command adjusts a rotational speed of the compressor. In a fifth example that may include one or more of the first through fourth examples, the method includes where the compressor flow rate command or the compressor outlet pressure command adjusts a displacement of the compressor. In a sixth example that may include one or more of the first through fifth examples, the method includes where the vehicle climate control system heats a passenger cabin.

The method of FIG. 4 also provides for a method for controlling a vehicle climate control system, comprising: adjusting a compressor control parameter to a first value; adjusting a speed or a displacement of a compressor in response to the compressor control parameter while the compressor has not continuously operated for a predetermined amount of time after a time when the vehicle climate control system was manufactured; and adjusting the compressor control parameter to a second value in response to the compressor continuously operating for the predetermined amount of time after the time when the vehicle climate control system was manufactured. In a first example, the method further comprises adjusting the speed or the displacement of a compressor in response to the compressor control parameter being adjusted to the second value. In a second example that may include the first example, the method includes where the second value is based on a requested passenger cabin temperature. In a third example that may include one or both of the first and second examples, the method includes where the first value is not based on the requested passenger cabin temperature. In a fourth example that may include one or more of the first through third examples, the method includes where the compressor is driven via an electric machine.

As will be appreciated by one of ordinary skill in the art, routines described in FIG. 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, various embodiments of climate control systems for electric vehicles, hybrid vehicles, and conventional vehicles (e.g., vehicles that have an internal combustion engine as a sole propulsion source) could use the present description to advantage.

1. A method for controlling a vehicle climate control system, comprising:
adjusting a compressor flow rate command or a compressor outlet pressure command to be less than a first threshold compressor flow rate or less than a first threshold compressor outlet pressure in response to a compressor being activated for a first time since the vehicle climate control system was manufactured.

2. The method of claim 1, where the compressor flow rate command is adjusted before or within a predetermined amount of time since most recently activating the compressor.

3. The method of claim 1, where the compressor outlet pressure command is adjusted before or within a predetermined amount of time since most recently activating the compressor.

4. The method of claim 1, where the first threshold compressor flow rate is less than a vehicle climate control system compressor flow rate command that is based on a requested passenger cabin temperature when the compressor flow rate command is adjusted, or where the first threshold compressor outlet pressure is less than a vehicle climate control system compressor outlet pressure command that is based on the requested passenger cabin temperature when the compressor outlet pressure command is adjusted.

5. The method of claim 1, where the compressor flow rate command or the compressor outlet pressure command adjusts a rotational speed of the compressor.

6. The method of claim 1, where the compressor flow rate command or the compressor outlet pressure command adjusts a displacement of the compressor.

7. The method of claim 1, where the vehicle climate control system heats a passenger cabin.

8. A vehicle climate control system, comprising:
a variable speed compressor or a variable displacement compressor; and
a controller including executable instructions stored in non-transitory memory that cause the controller to adjust the variable speed compressor or the variable displacement compressor in response to the variable speed compressor or the variable displacement compressor being activated for a first time since a predetermined time.

9. The vehicle climate control system of claim 8, where the variable speed compressor or the variable displacement compressor being activated includes rotating an input shaft of the variable speed compressor or the variable displacement compressor.

10. The vehicle climate control system of claim 8, where the predetermined time is a time the vehicle climate control system was manufactured.

11. The vehicle climate control system of claim 8, where the predetermined time is a most recent time when the vehicle climate control system was deactivated for longer than a predetermined amount of time.

12. The vehicle climate control system of claim 11, where the predetermined amount of time is greater than four hours.

13. The vehicle climate control system of claim 8, where adjusting the variable speed compressor includes reducing a speed of the variable speed compressor below a speed request that is based on a requested passenger cabin temperature.

14. The vehicle climate control system of claim 8, where adjusting the variable displacement compressor includes reducing a displacement of the variable speed compressor below a displacement request that is based on a requested passenger cabin temperature.

15. The vehicle climate control system of claim 14, further comprising an electric machine, the electric machine mechanically coupled to the variable speed compressor.

16. A method for controlling a vehicle climate control system, comprising:
adjusting a compressor control parameter to a first value;
adjusting a speed or a displacement of a compressor in response to the compressor control parameter while the compressor has not continuously operated for a predetermined amount of time after a time when the vehicle climate control system was manufactured; and
adjusting the compressor control parameter to a second value in response to the compressor continuously operating for the predetermined amount of time after the time when the vehicle climate control system was manufactured.

17. The method of claim 16, further comprising adjusting the speed or the displacement of the compressor in response to the compressor control parameter being adjusted to the second value.

18. The method of claim 17, where the second value is based on a requested passenger cabin temperature.

19. The method of claim 18, where the first value is not based on the requested passenger cabin temperature.

20. The method of claim 16, where the compressor is driven via an electric machine.
